(19) United States
(12) Patent Application Publication
(10) Pub. No.: US 2015/0138047 A1
(43) Pub. Date: May 21, 2015

(54) HEAD-UP DISPLAY SYSTEM

(71) Applicants: Chwen-Tay Hwang, Hsin-Chu (TW); Chi-Wu Hsiao, Hsin-Chu (TW); Hsi-Ming Wang, Hsin-Chu (TW)

(72) Inventors: Chwen-Tay Hwang, Hsin-Chu (TW); Chi-Wu Hsiao, Hsin-Chu (TW); Hsi-Ming Wang, Hsin-Chu (TW)

(73) Assignee: CORETRONIC CORPORATION, Hsin-Chu (TW)

(21) Appl. No.: 14/459,310

(22) Filed: Aug. 13, 2014

(30) Foreign Application Priority Data
Nov. 21, 2013 (TW) 102142499

(51) Int. Cl. G02B 27/01

(52) U.S. Cl. CPC G02B 27/0101; G02B 2027/0123; G02B 2027/013
USPC 345/7

(57) ABSTRACT

A head-up display system includes a head-up display and an image detecting unit. The head-up display includes a first control unit, an image source, and an optical system. The first control unit is configured to correct an image signal. The image source is coupled to the first control unit and configured to output an image beam according to the corrected image signal. The optical system is disposed on a transmission path of the image beam. The image detecting unit is disposed at a side of the head-up display to detect a deviation angle of a user with respect to the head-up display. Here, the first control unit corrects the image signal in advance according to the deviation angle of the user with respect to the head-up display and according to an aberration generated by the optical system.

### CROSS-REFERENCE TO RELATED APPLICATION

This application claims the priority benefit of Taiwan application serial no. 102142499, filed on Nov. 21, 2013. The entirety of the above-mentioned patent application is hereby incorporated by reference herein and made a part of this specification.

### BACKGROUND

1. Field of the Disclosure

The invention relates to a display system and more particularly to an automotive head-up display system.

2. Description of Related Art

With the rising demands of electronic components used in transportation, various display apparatuses employed in transportation have been successively developed. A conventional display apparatus is commonly installed on a dashboard of a vehicle. However, traffic safety concerns are likely to arise when a driver looks down to the display apparatus installed on the dashboard and is not able to observe the traffic conditions. Accordingly, an image beam may be projected onto the windshield by the display apparatus (e.g., a head-up display), and such a display apparatus has been extensively applied.

The head-up displays are commonly applied to aircrafts as supplementary equipment of aviation. Some automobiles are also equipped with the head-up displays, so as to project status data (e.g., car speed, vehicle conditions, etc.) onto the windshields for drivers' reference. As shown in FIG. 1, the conventional automotive head-up display 10 projects an image beam L onto a windshield 22 of the vehicle 20, such that a user U is able to observe a corresponding image frame I in a direction identical or similar to the direction of the vision of the user U. Thanks to the head-up display 10, the number of times of pulling the vision of the user U away from the road and the time spent on not watching the road may be both reduced, so as to further ensure the driving safety.

In order to display the significant amount of driving data, the head-up displays capable of displaying large image frames have been developed one after another, while such head-up displays are often bulky. On the other hand, if it is intended to reduce the dimensions of the head-up displays and simultaneously display the large image frames on such displays, the image frames displayed on these displays are apt to be distorted because of the configurations of optical components inside the head-up displays. As shown in FIG. 2, if an originally input image frame P1 is a rectangular image frame, the image frame P1 may be distorted after passing through the optical system of the head-up display 10, and thus the resultant image frame I observed by human eyes may be a fan-shaped image frame.

Besides, the deviation angle of the user with respect to the head-up display may vary according to the position of the user in the car or the sway in a moving car, and thus the image frame observed by the user may be deformed to different degrees (with different amount of deformation). As illustrated in FIG. 3, it is assumed that a deviation angle θ of a user U at a location X1 with respect to a head-up display 10 is zero, and an image frame I1 observed by the user U is a rectangular image frame. In this case, if the location of the user U with respect to the head-up display 10 is changed, the deviation angle θ of the user U with respect to the head-up display 10 is no longer zero, the image frames I2 and I3 projected by the head-up display 10 and respectively observed by the user U at locations X2 and X3 may be deformed to different degrees (with different amount of deformation), and therefore the rectangular image frame may become a tilted image frame shaped as a trapezoid. Moreover, as shown in FIG. 4, if the image frame P1 is distorted when the image frame P1 passes through the optical system of the head-up display 10, and the deviation angle θ of the user U with respect to the head-up display 10 is not zero, the deformed image frame I observed by the user may be a combination of said deformed and distorted image frames, which leads to difficulties in interpreting data. As a result, how to thin the thickness of the head-up display and resolve the issue of image deformation/distortion has become one of the topics for people in the related art.

U.S. Pat. No. 7,854,523 discloses a head-up display, wherein an image output from a display device is corrected by means of a wedge-shaped device. U.S. Patent Publication no. 2010/0157430 discloses an automotive display system. P. R.C. Patent no. 102745084 discloses an automotive head-up display apparatus capable of correcting an aberration by means of an image correcting lens.

### SUMMARY OF THE DISCLOSURE

The invention is directed to a head-up display system capable of resolving an issue of deformation/distortion of image frames.

Additional aspects and/or advantages of the invention will be set forth in part in the description which follows and, in part, will be obvious from the description or may be learned by practice of the invention.

To achieve one of, a part of or all of the above-mentioned objectives, or to achieve other objectives, an embodiment of the invention provides a head-up display system that includes a head-up display and an image detecting unit. The head-up display includes a first control unit, an image source, and an optical system. The first control unit is configured to correct an image signal. The image source is coupled to the first control unit and configured to receive the image signal and output an image beam according to the corrected image signal. The optical system is disposed on a transmission path of the image beam. The image detecting unit is disposed at a side of the head-up display and configured to detect a deviation angle of a user with respect to the head-up display. Here, the first control unit corrects the image signal in advance according to the deviation angle of the user with respect to the head-up display and according to an aberration generated by the optical system.

According to an embodiment of the invention, the image source includes an illumination module and a light valve. The illumination module is configured to emit an illumination beam. The light valve is disposed on a transmission path of the illumination beam and coupled to the first control unit, so as to convert the illumination beam into the image beam.

According to an embodiment of the invention, the head-up display system further includes a light detecting unit and a second control unit. The light detecting unit is disposed at the periphery of the image source to detect light intensity of the illumination beam or light intensity of the image beam and output a detection value according to the light intensity of the illumination beam or the light intensity of the image beam. The second control unit is coupled to the light detecting unit and the illumination module, wherein the second control unit is configured to receive the detection value from the light detecting unit and adjust the light intensity of the illumination beam output by the illumination module.

According to an embodiment of the invention, the second control unit adjusts the light intensity of the illumination beam output by the illumination module according to a control signal, and if the detection value exceeds a predetermined range, the second control unit correspondingly adjusts the light intensity of the illumination beam output by the illumination module.

According to an embodiment of the invention, the image detecting unit detects a deviation angle of user's eyes with respect to the head-up display.

According to an embodiment of the invention, the optical system includes a plurality of reflection mirrors and a lens. The image beam is transmitted to the reflection mirrors and then transmitted to the lens.

According to an embodiment of the invention, the reflection mirrors include a first reflection mirror, a second reflection mirror, and a third reflection mirror, wherein at least one of the image source, the second reflection mirror, the third reflection mirror, and the lens tilts with respect to the first reflection mirror.

According to an embodiment of the invention, the image beam from the image source is reflected sequentially by the first reflection mirror, the second reflection mirror, the first reflection mirror, and the third reflection mirror, then the image beam passes through the lens.

According to an embodiment of the invention, the first reflection mirror and the second reflection mirror are planar mirrors, the third reflection mirror is a concave mirror, and the lens is a convex lens. The second reflection mirror and the third reflection mirror are disposed on the same side of the first reflection mirror, and the first reflection mirror and the second and third reflection mirrors are disposed on opposite sides of the image source. The image source and the lens are disposed on opposite sides of the first reflection mirror, wherein the image source is disposed between the first reflection mirror and the second reflection mirror, and the convex lens is disposed between the first reflection mirror and the third reflection mirror. Here, the first, second, and third reflection mirrors are all disposed between the image source and the lens.

According to an embodiment of the invention, the third reflection mirror is a pillar-shaped concave mirror, and the lens is a pillar-shaped convex lens.

According to an embodiment of the invention, a reflection surface of the third reflection mirror is bent in a first direction and is not bent in a second direction. At least one refraction surface of the pillar-shaped lens is bent in a third direction and is not bent in the first direction. The first direction is parallel to a horizontal direction of an image frame of the image source, the second direction and the third direction are respectively perpendicular to the first direction, and an angle is included between the second direction and the third direction.

According to an embodiment of the invention, the aberration generated by the optical system includes distortion.

In view of the above, the head-up display system described in the embodiments of the invention may have at least one of the following advantages. In an embodiment of the invention, the head-up display system includes the image detecting unit and the first control unit. The image detecting unit is able to detect the deviation angle of the user with respect to the head-up display, and the first control unit may automatically correct the image signal according to the deviation angle of the user with respect to the head-up display and according to the aberration generated by the optical system. Thereby, the image signal may be corrected beforehand, the image source may output the image beam according to the corrected image signal. In brief, the head-up display system provided herein has the miniaturized optical structure and is capable of resolving the issue of deformation/distortion of image frames.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates that an automotive head-up display is applied in transportation.

FIG. 2 is a schematic diagram illustrating an image frame before and after distortion.

FIG. 3 is a schematic diagram illustrating a relationship between a deformation/distortion degree of an image frame and a deviation angle of a user with respect to a head-up display.

FIG. 4 is a schematic diagram illustrating an image frame before and after deformation.

FIG. 5A and FIG. 5B are schematic diagrams illustrating a head-up display system according to an embodiment of the invention.

FIG. 6A and FIG. 6B are schematic cross-sectional diagrams respectively illustrating the third reflection minor and the lens depicted in FIG. 5A.

FIG. 7 is a schematic diagram illustrating an image frame before and after the image beam passes through the head-up display system depicted in FIG. 5A.

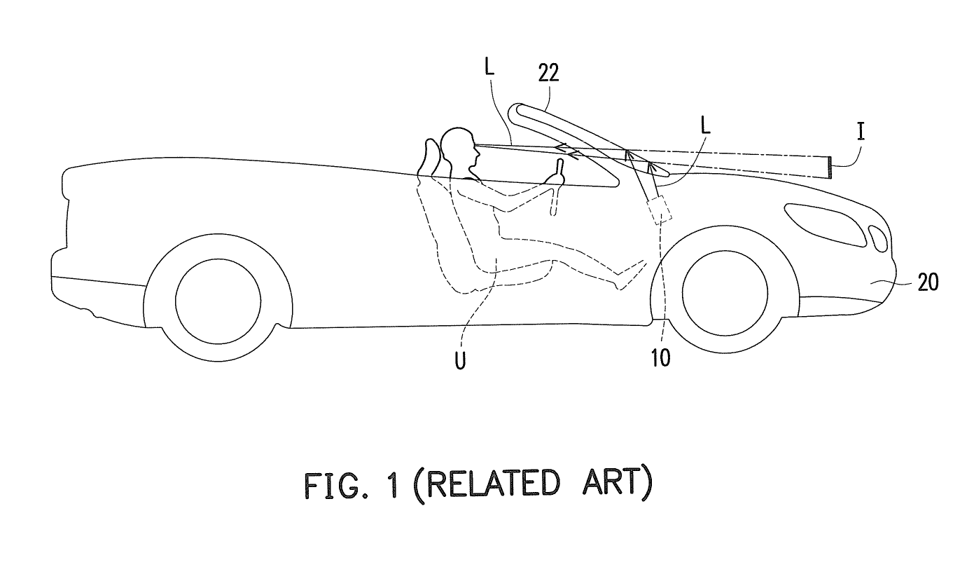

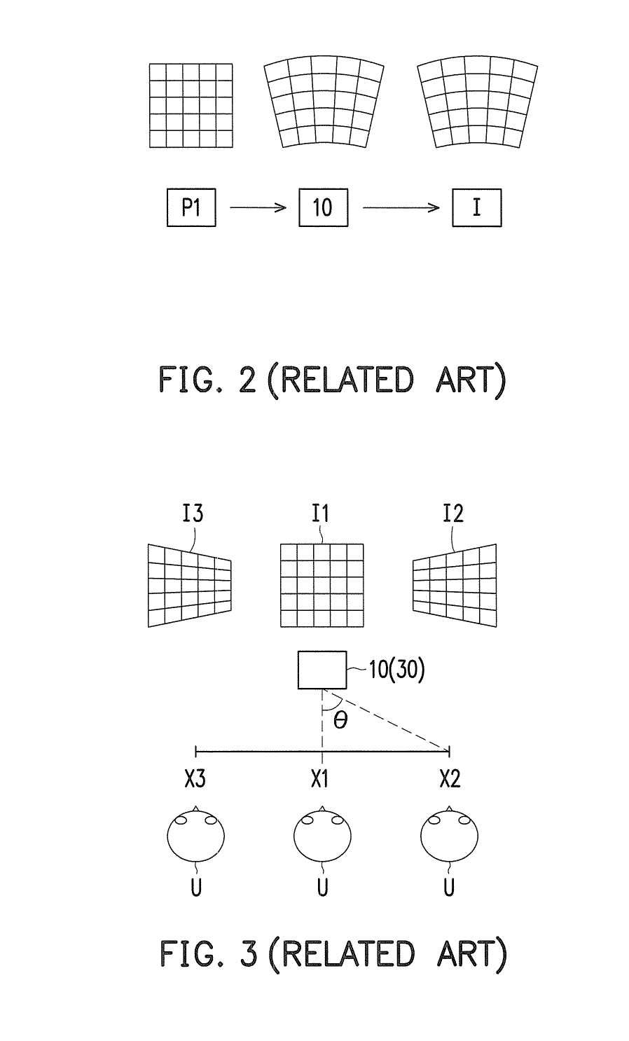

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention could be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

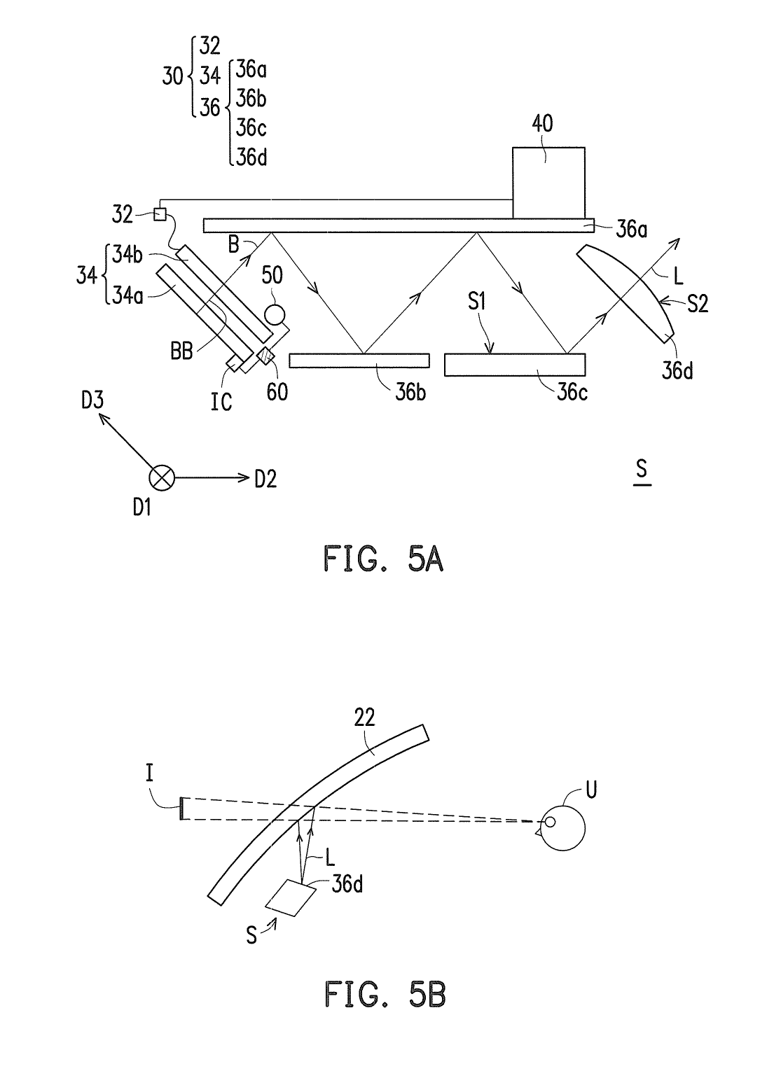

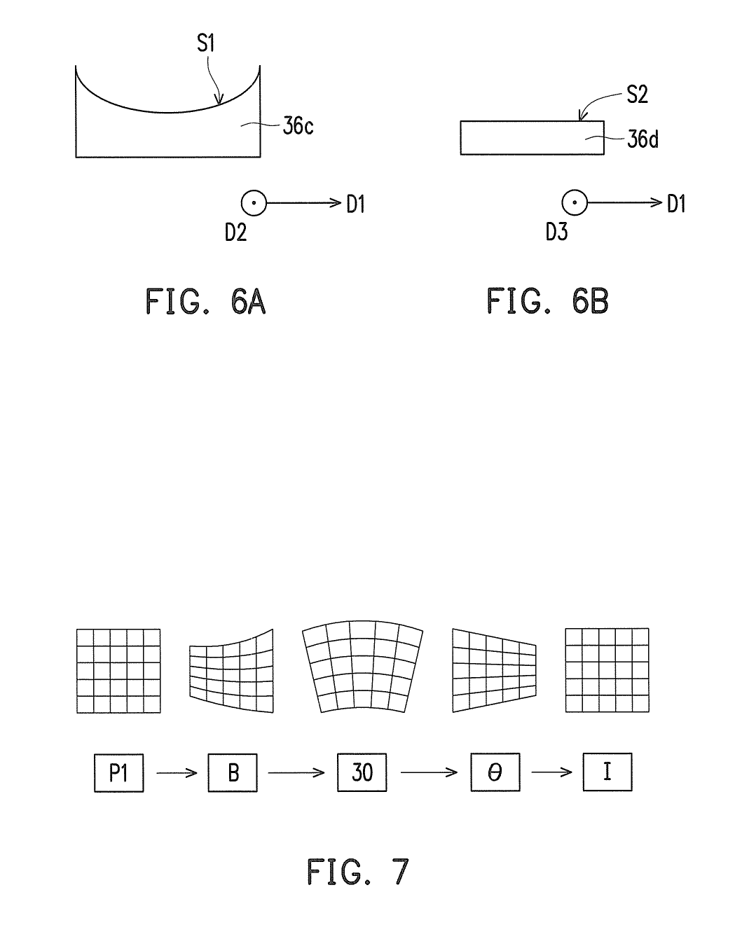

FIG. 5A and FIG. 5B are schematic diagrams illustrating a head-up display system according to an embodiment of the invention. FIG. 6A and FIG. 6B are schematic cross-sectional diagrams respectively illustrating the third reflection mirror and the lens depicted in FIG. 5A. With reference to FIG. 5A, FIG. 5B, FIG. 6A, and FIG. 6B, the head-up display system S described in the present embodiment includes a head-up display 30 and an image detecting unit 40. The head-up display 30 includes a first control unit 32, an image source 34, and an optical system 36.

The first control unit 32 is configured to correct an image signal from an image signal source (not shown). In an exemplary automotive head-up display, the information may be provided by the image signal source, wherein the image source may be at least one of a speed sensor, a door lock sensor, a temperature sensor, a fuel level detector, and any other detector or sensor; however, the invention is not limited thereto.

The image source 34 is coupled to the first control unit 32 and configured to receive the image signal from the first control unit 32, then output an image beam B according to the corrected image signal. According to the present embodiment, the image source 34 includes an illumination module 34a and a light valve 34b. The illumination module 34a is configured to emit an illumination beam BB. The light valve 34b is disposed on a transmission path of the illumination beam BB and coupled to the first control unit 32, so as to convert the illumination beam BB into the image beam B. For instance, the light valve 34b may be a transmissive liquid crystal panel, a digital micro-minor device (DMD), or a liquid-crystal-on-silicon (LCOS) panel.

The optical system 36 is disposed on a transmission path of the image beam B. Specifically, the optical system 36 includes a plurality of reflection mirrors and a lens 36d, and the image beam B is transmitted to the reflection mirrors and then transmitted to the lens 36d. According to the present embodiment, the reflection mirrors include a first reflection mirror 36a, a second reflection mirror 36b, and a third reflection mirror 36c. The image beam B from the image source 34 is reflected sequentially by the first reflection mirror 36a, the second reflection mirror 36b, the first reflection mirror 36a, and the third reflection mirror 36c, then the image beam B then passes through the lens 36d, so as to generate the image beam L output from the head-up display system S. In the present embodiment, the image beam L output from the head-up display system S may be projected onto the windshield 22 of the vehicle.

The second reflection mirror 36b and the third reflection mirror 36c are disposed on the same side of the first reflection mirror 36a, and the first reflection mirror 36a, the second reflection mirror 36b and third reflection mirror 36c are disposed on opposite sides of the image source 34. The image source 34 and the lens 36d are disposed on opposite sides of the first reflection mirror 36a, the image source 34 is disposed between the first reflection mirror 36a and the second reflection mirror 36b, and the lens 36d is disposed between the first reflection mirror 36a and the third reflection minor 36c. Besides, at least one of the image source 34, the second reflection mirror 36b, the third reflection mirror 36c, and the lens 36d tilts with respect to the first reflection mirror 36a. In the present embodiment, the image source 34 and the lens 36d tilt toward the same side. According to the said arrangement, the total area occupied by the optical system 36 may be effectively reduced, so as to thin the head-up display system S. Note that the image source 34 and the lens 36d may not be parallel to each other according to an embodiment of the invention.

According to the present embodiment, the first reflection mirror 36a and the second reflection mirror 36b are planar mirrors, the third reflection mirror is a concave minor 36c, and the lens 36d is a convex lens. In the present embodiment, the third reflection mirror 36c is a pillar-shaped concave mirror, and the lens 36d is a pillar-shaped convex lens. As illustrated in FIG. 5A, FIG. 6A, and FIG. 6B, a reflection surface S1 of the third reflection mirror 36c is bent in a first direction D1 and is not bent in a second direction D2, and at least one refraction surface S2 of the pillar-shaped convex lens 36d is bent in a third direction D3 and is not bent in the first direction D1. The first direction D1 is parallel to a horizontal direction of an image frame of the image source 34, the second direction D2 and the third direction D3 are respectively perpendicular to the first direction D1, wherein an angle is included between the second direction D2 and the third direction D3. The refraction surface S2 of the pillar-shaped convex lens 36d described in the present embodiment faces to the surface of windshield 22.

The image detecting unit 40 is disposed at a side of the head-up display 30 and configured to detect a deviation angle θ (shown in FIG. 3) of the user U with respect to the head-up display 30. For instance, the image detecting unit 40 may be a charge-coupled device (CCD) or a complementary metal-oxide semiconductor (CMOS) sensor.

According to the present embodiment, the image detecting unit 40 is disposed on the head-up display 30, however, the relative arrangement of the image detecting unit 40 and the head-up display 30 is not limited to the above. Particularly, the image detecting unit 40 is at a location that allows the image detecting unit 40 to detect the deviation angle θ of the user U with respect to the head-up display 30. In other embodiment of the invention, the image detecting unit 40 may also be disposed on a side surface or a bottom surface of the head-up display 30. In addition, the image detecting unit 40 is able to detect the location of eyes of the user U. To be specific, the image detecting unit 40 may detect the deviation angle θ of the user U with respect to the head-up display 30 by human eye recognition or human face recognition. According to the help of human eye recognition, the image detecting unit 40 is also capable of determining whether the user U dozes off; through the warning alarm, the driving safety may be further guaranteed.

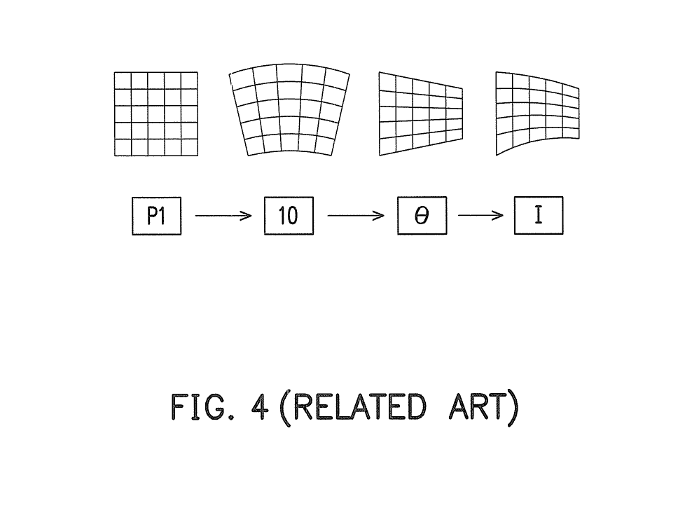

FIG. 7 is a schematic diagram illustrating an image frame before and after the image beam passes through the head-up display system depicted in FIG. 5A. With reference to FIG. 3, FIG. 4, FIG. 5A, FIG. 5B, and FIG. 7, the first control unit 32 described in the present embodiment corrects the image signal in advance according to the deviation angle θ (shown in FIG. 3) of the user U with respect to the head-up display 30 and according to an aberration generated after the image beam L passes through the optical system 36 of the head-up display 30, wherein the aberration includes distortion. According to the framework shown in FIG. 4, the originally input image frame P1 is distorted after passing through the optical system of the head-up display 10 because of the design and the arrangement of the optical components in the optical system, such that the resultant image frame I observed by human eyes may be a fan-shaped image frame. In addition, if the deviation angle of the user U with respect to the head-up display 30 is not zero, the image frame observed by human eyes is deformed to certain degree (with certain amount of deformation), and the observed image frame is similar to a tilted image frame shaped as a trapezoid. Given that said two conditions are met simultaneously, the image frame I output from the head-up display may be shaped in a manner similar to a combination of said fan-shaped and trapezoidal image frames.

In view of the above, since the image signal described in the present embodiment is corrected in advance and input to the image source 34, the image source 34 is allowed to receive the corrected image signal and correspondingly outputs the image beam B, and the correction beforehand includes both the aberration generated after the image beam L passes through the optical system 36 of the head-up display 30 and the amount of deformation resulting from the deviation angle θ of the user U with respect to the head-up display 30. Thereby, the pattern formed by projecting the image beam B and the image frame I shown in FIG. 4 are mutually compensated. In other words, the pattern formed by projecting the image beam B is a left-right inverted and top-bottom inverted pattern of the image frame I shown in FIG. 4. After the image beam L output from the head-up display system S is projected onto the windshield 22 of the vehicle, the image frame I observed by the user U, as shown in FIG. 7, is substantially identical to the originally input image frame P1. Hence, the head-up display system S provided in the present embodiment may have the thin optical structure and is able to resolve the conventional issue of deformation/distortion of the image frame I.

As shown in FIG. 5A, the head-up display system S described in the present embodiment may further include a light detecting unit 50 and a second control unit 60, so as to periodically correct the light intensity of the illumination beam B output from the image source 34 and ensure that the light intensity of the illumination beam B output from the image source 34 within its service life may constantly fall within a certain range.

In detail, the light detecting unit 50 is disposed at the periphery of the image source 34 to detect the light intensity of the illumination beam BB or the light intensity of the image beam B. In the present embodiment, the light detecting unit 50 is configured adjacent to the imaging side of the light valve 34b for displaying the image frame, however, the invention is not limited thereto. In another embodiment of the invention, the light detecting unit 50 may also be disposed between the illumination module 34a and the light valve 34b, so as to detect the light intensity of the illumination beam BB.

The light detecting unit 50 outputs the detection value according to the detected light intensity of the illumination beam BB or the detected light intensity of the image beam B. Here, the light detecting unit 50 may continuously detect the light intensity of the illumination beam BB or the light intensity of the image beam B. The light detecting unit 50 may also be configured to detect the light intensity of the white frame during the start-up of a computer. It is also likely for the light detecting unit 50 to be set to periodically detect the light intensity of the illumination beam BB or the light intensity of the image beam B.

The second control unit 60 is coupled to the light detecting unit 50 and the illumination module 34a to receive the detection value from the light detecting unit 50 and modulate the light intensity of the illumination beam B output by the illumination module 34a. In the present embodiment, the second control unit 60 controls a driver chip IC in the illumination module 34a according to a control signal, so as to modulate the light intensity of the illumination beam B output by the illumination module 34a. If the detection value is below a predetermined range, the second control unit 60 enhances the light intensity of the illumination beam B output by the illumination module 34a, such that the reduced light intensity is compensated; if the detection value exceeds the predetermined range, the second control unit 60 reduces the light intensity of the illumination beam B output by the illumination module 34a, such that the light intensity may stay within the predetermined range. Thereby, the service life of the image source 34 may last long. The control signal may be a pulse width modulation (PWM) signal or a voltage level signal, and the second control unit 60 may be a microcontroller (MCU), any other appropriate controller, or any electronic apparatus in which an appropriate controller is installed.

The second control unit 60 and the illumination module 34a are electrically connected to each other through a physical circuit in the present embodiment, however, the invention is not limited thereto. In another embodiment of the invention, the second control unit 60 may also control the driver chip in the illumination module 34a through wireless transmission.

In the present embodiment, the first control unit 32 and the second control unit 60 are implemented in form of hardware. For instance, the first control unit 32 may be implemented in form of a digital logic circuit. Nevertheless, in another embodiment of the invention, the first control unit 32 and the second control unit 60 may also be implemented in form of software. For instance, the first control unit 32 may include a processor, a random access memory (RAM) electrically connected to the processor, and a non-volatile memory (e.g., a read-only memory (ROM) or a flash memory) electrically connected to the RAM. When the first control unit 32 is being operated, the program commands stored in the non-volatile memory are loaded into the RAM and then loaded into the processor. Thus, the processor is able to execute the same function as the first control unit 32. In other words, the first control unit 32 and the second control unit 60 are firmware.

To sum up, the head-up display system described herein includes the image detecting unit and the first control unit. The image detecting unit is able to detect the deviation angle of the user with respect to the head-up display, and the first control unit may automatically correct the image signal according to the deviation angle of the user with respect to the head-up display and according to the aberration generated by the optical system. Thereby, the image source may output the image beam according to the corrected image signal. In brief, the head-up display system provided herein has the miniaturized optical structure and is capable of resolving the issue of deformation/distortion of image frames.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Apparently, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A head-up display system comprising:
a head-up display comprising:
a first control unit configured to correct an image signal;
an image source coupled to the first control unit and configured to receive the image signal and output an image beam according to the corrected image signal; and
an optical system disposed on a transmission path of the image beam; and
an image detecting unit disposed at a side of the head-up display and configured to detect a deviation angle of a user with respect to the head-up display, wherein the first control unit corrects the image signal in advance according to the deviation angle of the user with respect to the head-up display and according to an aberration generated by the optical system.

2. The head-up display system as recited in claim 1, wherein the image source comprises an illumination module and a light valve, the illumination module is configured to emit an illumination beam, and the light valve is disposed on a transmission path of the illumination beam and coupled to the first control unit, so as to convert the illumination beam into the image beam.

3. The head-up display system as recited in claim 2 further comprising: a light detecting unit and a second control unit, wherein the light detecting unit is disposed at a periphery of the image source to detect light intensity of the illumination beam or light intensity of the image beam and output a detection value according to the light intensity of the illumination beam or the light intensity of the image beam, and the second control unit is coupled to the light detecting unit and the illumination module and configured to receive the detection value from the light detecting unit and modulates the light intensity of the illumination beam output by the illumination module.

4. The head-up display system as recited in claim 3, wherein the second control unit adjusts the light intensity of the illumination beam output by the illumination module according to a control signal, and if the detection value exceeds a predetermined range, the second control unit correspondingly adjusts the light intensity of the illumination beam output by the illumination module.

5. The head-up display system as recited in claim 1, wherein the image detecting unit detects a deviation angle of eyes of the user with respect to the head-up display.

6. The head-up display system as recited in claim 1, wherein the optical system comprises a plurality of reflection mirrors and a lens, and the image beam output from the image source is transmitted to the reflection mirrors and then transmitted to the lens.

7. The head-up display system as recited in claim 6, wherein the reflection mirrors comprise a first reflection mirror, a second reflection mirror, and a third reflection mirror, and at least one of the image source, the second reflection mirror, the third reflection mirror, and the lens tilts with respect to the first reflection mirror.

8. The head-up display system as recited in claim 7, wherein the image beam from the image source is reflected sequentially by the first reflection mirror, the second reflection mirror, the first reflection mirror, and the third reflection mirror, and the image beam then passes through the lens.

9. The head-up display system as recited in claim 8, wherein the first reflection mirror and the second reflection mirror are planar mirrors, the third reflection mirror is a concave minor, the lens is a convex lens, the second reflection mirror and the third reflection mirror are disposed on a same side of the first reflection mirror, the first reflection mirror and the second and third reflection minors are disposed on opposite sides of the image source, the image source and the lens are disposed on opposite sides of the first reflection minor, the image source is disposed between the first reflection mirror and the second reflection minor, and the lens is disposed between the first reflection minor and the third reflection minor.

10. The head-up display system as recited in claim 9, wherein the third reflection minor is a pillar-shaped concave minor, and the lens is a pillar-shaped convex lens.

11. The head-up display system as recited in claim 10, wherein a reflection surface of the third reflection mirror is bent in a first direction and is not bent in a second direction, at least one refraction surface of the lens is bent in a third direction and is not bent in the first direction, the first direction is parallel to a horizontal direction of an image frame of the image source, the second direction and the third direction are respectively perpendicular to the first direction, and an angle is included between the second direction and the third direction.
